(19) United States
(12) Patent Application Publication
(10) Pub. No.: US 2017/0242501 A1
(43) Pub. Date: Aug. 24, 2017

(54) CAPACITIVE STYLUS WITH REPLACEABLE CONDUCTIVE NIB

(71) Applicant: WALTOP INTERNATIONAL CORPORATION, Hsinchu City (TW)

(72) Inventors: Ying-Hwa Tang, Hsinchu City (TW); Yi-Chih Chang, Hsinchu City (TW); Hsin-Chiang Ho, Hsinchu City (TW)

(21) Appl. No.: 15/069,891

(22) Filed: Mar. 14, 2016

(30) Foreign Application Priority Data
Feb. 22, 2016 (TW) 105105155

(51) Int. Cl. G06F 3/0354

(52) U.S. Cl. CPC G06F 3/03545

(57) ABSTRACT

A capacitive stylus with a replaceable conductive nib is disclosed. The capacitive stylus comprises a combination of a replaceable conductive nib and a tip.

### CROSS-REFERENCE TO RELATED APPLICATIONS

The entire contents of Taiwan Patent Application No. 105105155, filed on Feb. 22, 2016, from which this application claims priority, are expressly incorporated herein by reference.

1. Field of the Invention

The present invention relates to a capacitive stylus, and more particularly to a capacitive stylus with an a replaceable conductive nib and a non-conductive tip.

2. Description of the Prior Art

Capacitive touch input technology being the main technology used in the touch panel is widely applied in mobile communication devices, tablet computers or any device with a touch display. one of advantages of the capacitive touch input technology is allowing user to proceed input operation via user's hand and a capacitive stylus. Input operation via user's hand can perform multi touch control, but not suitable for a more delicate input operation, such as writing or drawing input operations with stroke thickness changes. Thus a capacitive stylus instead of user's hand is used to perform exquisite writing or drawing input operation upon a touch panel with a capacitive touch input function.

The invention provide a capacitive stylus with a replaceable conductive nib and a non-conductive tip which allows users to change the conductive nib and arbitrarily replace the non-conductive tip with other non-conductive tips of various designs so as to meet the requirements of proceeding exquisite and multifunctional writing or drawing input operation on a touch panel.

### SUMMARY OF THE INVENTION

One object of the present invention is to provide a capacitive stylus with a replaceable conductive nib and various interchangeable non-conductive tips to meet various requirements and likes of the users.

According to the object, one embodiment of the present invention provides a capacitive stylus with a replaceable nib. The capacitive stylus comprises a replaceable conductive nib and a tip, a nib holder and a control circuit board. One end of the conductive nib comprises a male thread, the conductive nib combines with the tip via the end with the male thread tapping into one end of the tip. The conductive nib penetrates and combines with the nib holder. The conductive nib and the nib holder electrically connect to the control circuit board.

In another embodiment of the present invention, the capacitive stylus comprises a replaceable conductive nib and a tip, a nib holder and a control circuit board. One end of the conductive nib comprises at least one bulge, one end of the tip is hollow to accommodate the end of the conductive nib with the bulge, the hollow end of the tip comprises at least one concave to accommodate the bulge, when the end of the conductive nib with the bulge is installed into the hollow end of the tip, the bulge of the conductive nib is pressed into the concave of the tip so that the conductive nib can combine with the tip. The conductive nib penetrates and combines with the nib holder. The conductive nib and the nib holder electrically connect to the control circuit board.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1A is a schematic view of a capacitive stylus according to one embodiment of the invention.

FIG. 1B is a schematic cross sectional view of a capacitive stylus according to one embodiment of the invention.

FIG. 2A is a schematic view of a tip of a capacitive stylus according to one embodiment of the invention.

FIG. 2B is a schematic view of a conductive nib of a capacitive stylus according to one embodiment of the invention.

FIG. 2C is a schematic view of a nib assembly of the tip and the conductive nib according to one embodiment of the invention.

FIG. 2D is a schematic view of a nib assembly of the tip and the conductive nib according to another embodiment of the invention.

FIG. 3A is a schematic view of the tip 101a installed on a conductive nib according to one embodiment of the invention.

FIG. 3B to FIG. 3E are schematic views of tips installed on a conductive nib according to embodiments of the invention.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

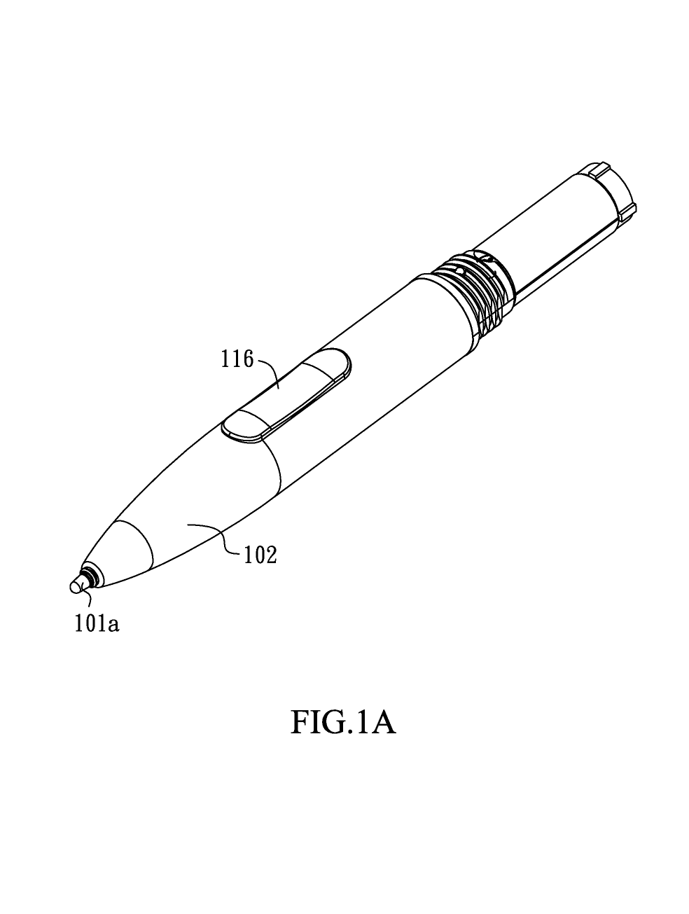

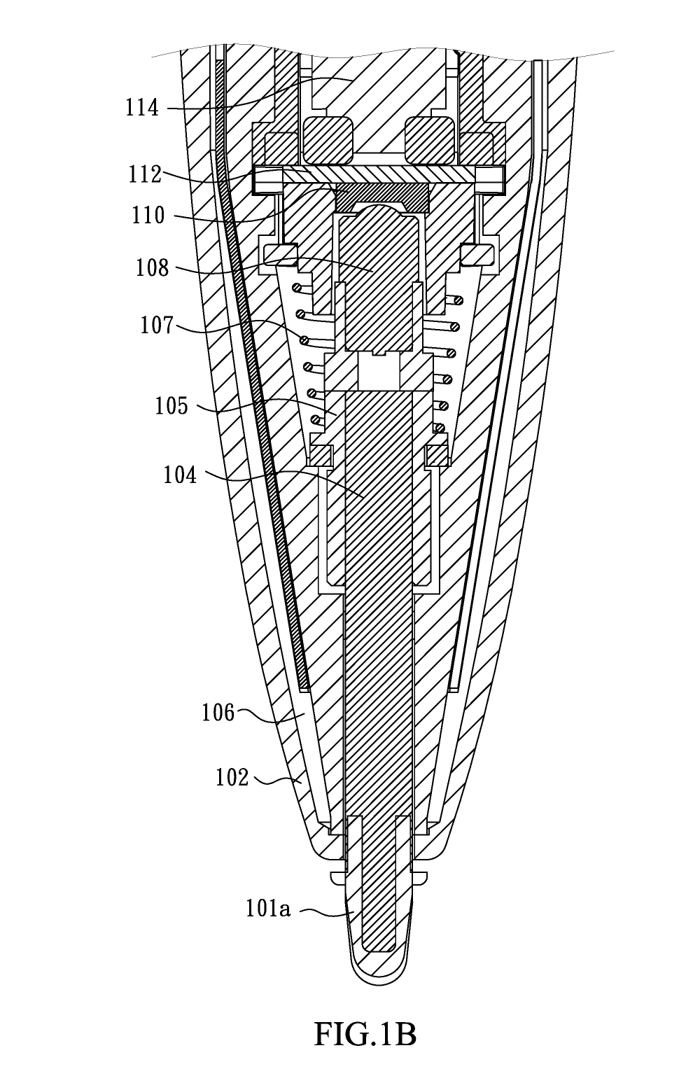

FIG. 1A is a schematic view of a capacitive stylus according to one embodiment of the invention. In this embodiment, the capacitive stylus comprises a tip 101a, a stylus tube 102, and a button 116. The stylus tube 102 comprises a front tube which can be combined with a rear tube (not shown) as an outer shell of the capacitive stylus so as to accommodate components of the capacitive stylus.

FIG. 1B is a schematic cross sectional view of a capacitive stylus according to one embodiment of the invention. In this embodiment, the capacitive stylus comprises the tip 101a, the stylus tube 102, a conductive nib 104, a nib holder 105, a shield 106, a spring 107, an elastomer 108, a pressure sensor 110, a pressure sensor board 112 an a control circuit board 114. The tip 101a and the conductive nib 104 are configured to be combined to form a nib assembly. More contents about the configurations and assembling embodiments of the tip 101a and the conductive nib 104 will be further described in the following description. The material of the tip 101a comprises plastic, such as polyoxymethylene (POM) and thermoplastic polyurethane (TPU). The conductive nib 104 comprises a replaceable conductive nib. The material of the conductive nib 104 comprises metals, such as stainless steel, or any suitable electrical conductive materials. The nib holder 105 is configured to secure and contact with the conductive nib 104. The material of the nib holder 105 comprises any suitable electrical conductive materials, but preferably metals. The spring 107 is configured to surround and contact with the nib holder 105 so as to connect the conductive nib 104 and the nib holder 105 to the control circuit board 114. The material of the spring 110 is preferably metals. The shield 106 is configured to shield noises. The materials of the shield 106 comprises any suitable electrical conductive materials, but preferably metals. The material of the elastomer 108 comprises, but not limited to, rubbers. The pressure sensor 110 is configured to be located on the pressure sensor board 112. The pressure sensor 110 and he pressure sensor board 112 are electrically connected to the control circuit board 114.

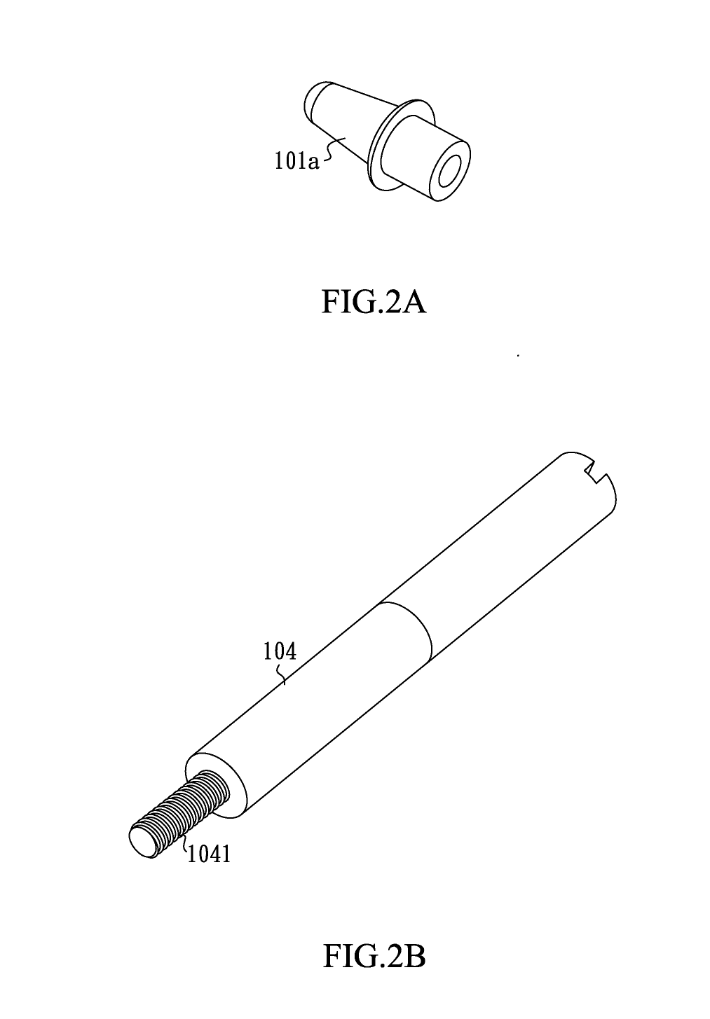

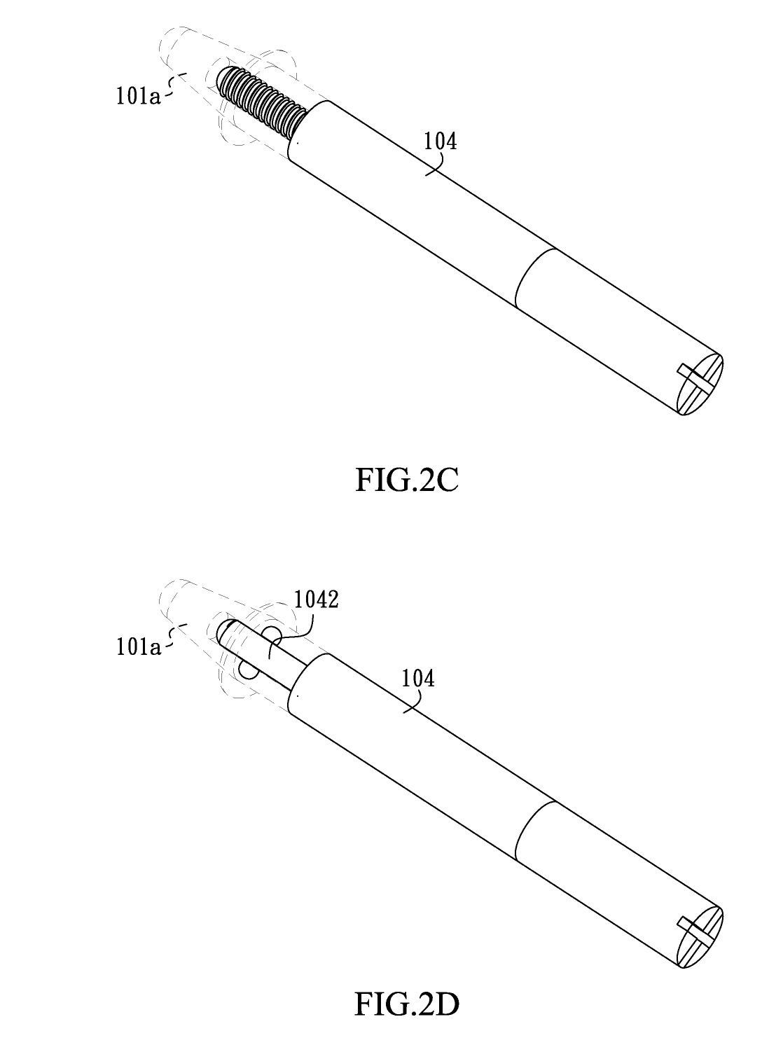

FIG. 2A is a schematic view of a tip of a capacitive stylus according to one embodiment of the invention. As shown in FIG. 2A, the tip 101a comprises a circular configuration used to decrease and disperse impact. As shown in FIG. 1, when the nib assembly of the tip 101a and the conductive nib 104 is installed in the nib holder 105, a gap is maintained between the circular configuration of the tip 101a and the front end of the stylus tube 102 such that when a pressure is applied on the tip 101a to move the conductive nib 104 toward the capacitive stylus, the circular configuration can lean against the front end of the capacitive stylus so as to prevent the conductive nib 104 from over retracting resulting in damages of internal components of the capacitive stylus.

FIG. 2B is a schematic view of a conductive nib of a capacitive stylus according to one embodiment of the invention. As shown in FIG. 2B, the end of the conductive nib 104 used to combine with the tip 101a comprises a male thread 1041. FIG. 2C is a schematic view of a nib assembly of the tip and the conductive nib according to one embodiment of the invention. In this embodiment, the conductive nib 104 is directly tapped into the tip 101a via the male thread 1041 so as to combine with the tip 101a, as shown in FIG. 2C.

FIG. 2D is a schematic view of a nib assembly of the tip and the conductive nib according to another embodiment of the invention. In this embodiment, the end of the conductive nib 104 used to combine with the tip 101a comprises at least one bulge, while one end of the tip 101a is hollow to accommodate the end of the conductive nib 104 with the bulge. The hollow end of the tip 101a comprises at least one concave to accommodate the bulge on the end of the conductive nib 104. When the end of the conductive nib 104 with the bulge is installed into the hollow end of the tip 101a, the bulge of the conductive nib 104 is pressed into the concave of the tip 101a so that the conductive nib 104 can combine with the tip 101a.

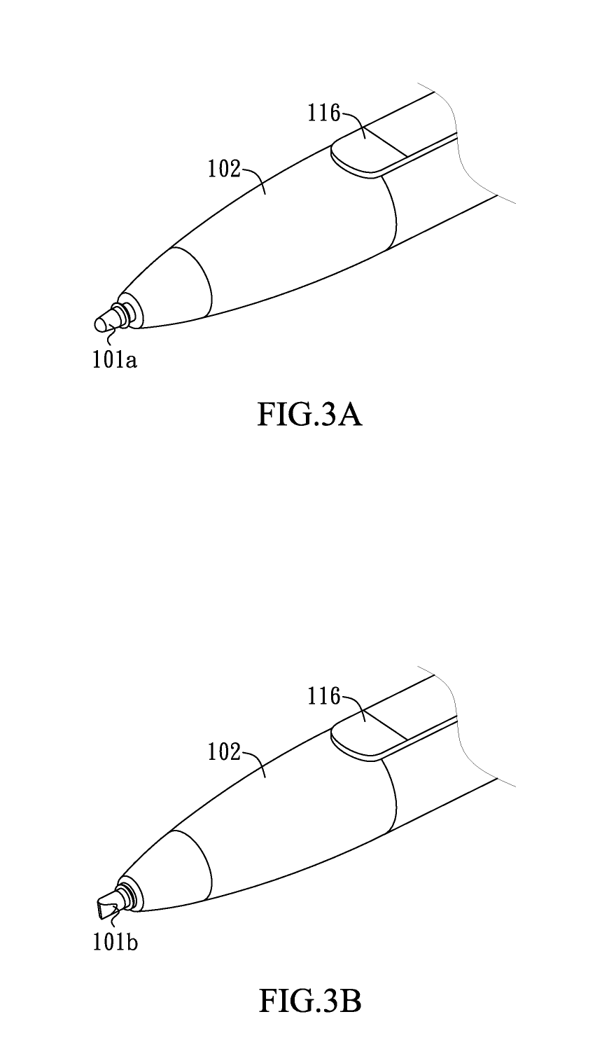

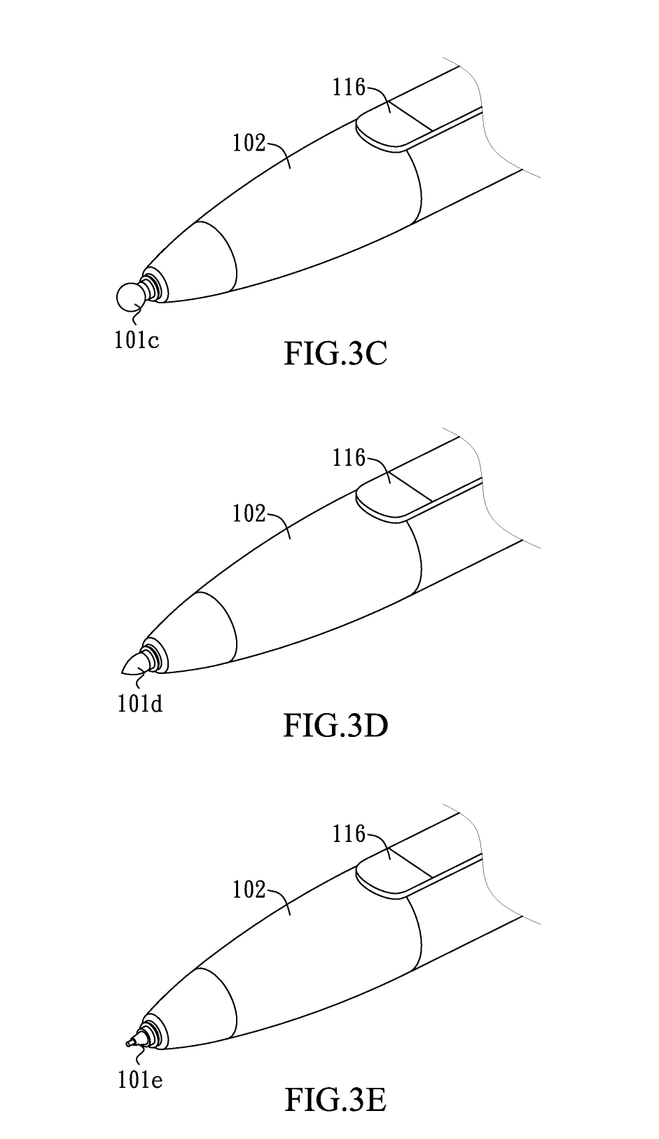

FIG. 3A is a schematic view of the tip 101a installed on a conductive nib according to one embodiment of the invention. FIG. 3A also shows the stylus tube 102 and the button 116. The button 116 is configured to allow user to operate switches (not shown) on the control circuit board 114 to select, turn on/off various functions of the capacitive stylus.

FIG. 3B to FIG. 3E are schematic views of tips installed on a conductive nib according to embodiments of the invention. FIG. 3B shows a marker pen tip 101b installed on a conductive nib. FIG. 3C shows a ballpoint pen tip 101c installed on a conductive nib. FIG. 3D shows a writing brush tip 101d installed on a conductive nib. FIG. 3E shows a fine writing tip 101d installed on a conductive nib. The materials of the marker pen tip 101b, the ballpoint pen tip 101c and the fine writing tip 101d comprise plastic, such as polyoxymethylene and thermoplastic polyurethane. The marker pen tip 101b, the ballpoint pen tip 101c and the fine writing tip 101d can be installed on the conductive nib 104 shown in FIG. 2B via the conductive nib 104 directly tapping into the marker pen tip 101b, the ballpoint pen tip 101c and the fine writing tip 101d. One end of each the marker pen tip 101b, the ballpoint pen tip 101c and the fine writing tip 101d is hollow with at least one concave to accommodate the end of the conductive nib 104 with the bulge. When the end of the conductive nib 104 with the bulge is installed into the hollow end of the marker pen tip 101b, the ballpoint pen tip 101c or the fine writing tip 101d, the bulge of the conductive nib 104 is pressed into the concave of the marker pen tip 101b, the ballpoint pen tip 101c or the fine writing tip 101d so that the conductive nib 104 can combine with the marker pen tip 101b, the ballpoint pen tip 101c or the fine writing tip 101d. The capacitive stylus of the invention provides users with a replaceable conductive nib and various interchangeable non-conductive tips to meet various requirements and likes of the users.

It is noted that the configuration, shape and material of the components of the embodiment mentioned above and shown are examples instead of limitations, any equivalents, alternatives or modifications of the embodiment corresponding to the spirit of invention should be encompassed in the scope of the invention. More details about configurations and components such as a power source of the capacitive stylus according to embodiments of the invention which are known, appreciated and enabled by those with ordinary skill in the art are omitted herein.

Although specific embodiments have been illustrated and described, it will be appreciated by those skilled in the art that various modifications may be made without departing from the scope of the present invention, which is intended to be limited solely by the appended claims.

What is claimed is:

1. A capacitive stylus with a replaceable nib, comprising:
a replaceable conductive nib and a tip, one end of the conductive nib comprising a male thread, the conductive nib combining with the tip via the end with the male thread tapping into one end of the tip;
a nib holder; the conductive nib penetrating and combining with the nib holder; and
a control circuit board, the conductive nib and the nib holder electrically connecting to the control circuit board.

2. The capacitive stylus according to claim 1, wherein the tip comprises a circular configuration.

3. The capacitive stylus according to claim 2, wherein a gap is maintained between the circular configuration and a front end of a stylus tube of the capacitive stylus such that when a pressure is applied on the tip to move the conductive nib toward the capacitive stylus, the circular configuration can lean against the front end of the capacitive stylus so as to prevent the conductive nib from over retracting resulting in damages of internal components of the capacitive stylus.

4. The capacitive stylus according to claim 1, wherein the tip comprises a marker pen tip, a ballpoint pen tip and a fine writing tip.

5. The capacitive stylus according to claim 1, wherein the material of the tip comprises plastic.

6. The capacitive stylus according to claim 1, wherein the material of the tip comprises preferably polyoxymethylene and thermoplastic polyurethane.

7. The capacitive stylus according to claim 1, wherein the material of the conductive nib comprises stainless steel.

8. A capacitive stylus with a replaceable nib, comprising:
a replaceable conductive nib and a tip, one end of the conductive nib comprising at least one bulge, one end of the tip being hollow to accommodate the end of the conductive nib with the bulge, the hollow end of the tip comprising at least one concave to accommodate the bulge, when the end of the conductive nib with the bulge being installed into the hollow end of the tip, the bulge of the conductive nib being pressed into the concave of the tip so that the conductive nib can combine with the tip;
a nib holder, the conductive nib penetrating and combining with the nib holder; and
a control circuit board, the conductive nib and the nib holder electrically connecting to the control circuit board.

9. The capacitive stylus according to claim 8, wherein the tip comprises a marker pen tip, a ballpoint pen tip and a fine writing tip.

10. The capacitive stylus according to claim 8, wherein the material of the tip comprises plastic.

11. The capacitive stylus according to claim 8, wherein the material of the tip comprises preferably polyoxymethylene and thermoplastic polyurethane.

12. The capacitive stylus according to claim 8, wherein the material of the conductive nib comprises stainless steel.
